(19) United States
(12) Patent Application Publication
(10) Pub. No.: US 2006/0025883 A1
(43) Pub. Date: Feb. 2, 2006

(54) Integrated warehouse management system

(75) Inventor: Rob Reeves, Apple Valley, CA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: United Parcel Service of America, Inc., Atlanta, GA (US)

(21) Appl. No.: 10/903,883

(22) Filed: Jul. 30, 2004

(51) Int. Cl. G06F 7/00

(52) U.S. Cl. 700/216

(57) ABSTRACT

The present invention is generally directed to an improved order fulfillment system that provides a convenient and inexpensive way of ensuring the accuracy of items being packed at a packing location, that captures order-related detail data on a carton level, and that provides a way of determining an accurate carton value which can be used for such things as computing an appropriate COD or insurance value for each carton to be shipped to a consignee. The invention further includes aspects related to the integration of such carton level detail data with carton tracking data that corresponds to the movement of each carton through a transportation network.

### FIELD OF THE INVENTION

The present invention relates generally to improved systems and methods for ensuring order fulfillment accuracy and visibility for items packed at a packing location.

### BACKGROUND OF THE INVENTION

Orders received at a packing location, such as a warehouse, typically include a list of ordered goods that are to be shipped from the packing location to a consignee. Personnel working at the packing location typically fulfill each order by retrieving the items listed on the order and packing them into one or more cartons. Each of the individual cartons can then, in most cases, be handed over to a common carrier, such as UPS, for shipment to the consignee.

One problem associated with many prior art order fulfillment systems is that there is typically no convenient and inexpensive way to ensure the accuracy of the items being packed for shipment against the items that are actually listed on an order. Another problem associated with prior art order fulfillment systems is that they often provide no record of who packed what items into which particular carton, and when.

Accordingly, an unsatisfied need exists for improved systems and methods for conducting order fulfillment operations at a packing location that overcome the deficiencies in the prior art, some of which are discussed above.

### BRIEF SUMMARY OF THE INVENTION

The present invention is generally directed to an improved order fulfillment system that provides a convenient and inexpensive way of ensuring the accuracy of items being packed at a packing location, that captures order-related detail data on a carton level, and that provides a way of determining an accurate carton value which can be used for such things as computing an appropriate COD (Cash On Delivery) or insurance value for each carton to be shipped to a consignee.

In one embodiment of the present invention, a method of fulfilling an order at a packing facility is disclosed, wherein an order comprises a list of ordered goods that are to be packed into one or more cartons and shipped from the packing facility to a consignee. The disclosed method includes the steps of receiving at a computer an order number associated with the order; retrieving order information data associated with the order number, the order information data comprising a list of the ordered goods that are to be transported from the packing facility to the consignee; associating a first carton identifier with a carton, the carton to be used in the transporting of at least some of the ordered goods listed on the order; receiving at the computer at least one item identifier, each at least one item identifier associated with an item to be placed in the carton; validating each item identifier against the order information data to determine whether the item corresponds to an ordered good that should be placed in the carton; and for each the item determined to be valid, recording the item identifier in association with the first carton identifier to provide an indication that the item was placed in the carton.

In other embodiments of the present invention, the method described above may include one or more of the following steps: generating a signal indicating that an item should not be placed in the carton if the validating step determines that the item is not valid; displaying the order information data to an operator who is positioned to place the items into the carton; receiving at the computer a carton-complete signal indicating that no more items are to be placed in the carton; and printing a carton label to be affixed to the carton, the carton label comprising the first carton identifier described above.

In one embodiment, the carton complete-signal mentioned in the receiving step described above can include an indication that the current order is to be closed. In another embodiment, the carton complete-signal mentioned in the receiving step described above can include an indication that the current order is to remain open so that one or more of the ordered goods listed on the order can be packed into a next carton. In the latter of these embodiments, the method may further comprise the steps of: associating a next carton identifier with the next carton, which is to be used in the transporting of at least some of the ordered goods listed on the order; receiving at the computer at least one item identifier, each such item identifier being associated with an item to be placed in the next carton; validating each such item identifier against the order information data to determine whether the item corresponds to an ordered good that should be placed in the next carton; and for each said item determined to be valid, recording the item identifier in association with the next carton identifier to provide an indication that the item was placed in that carton.

In another embodiment of the present invention a method of fulfilling an order at a packing facility is disclosed, wherein an order includes a list of ordered goods that are packed into one or more cartons and shipped from said packing facility to a consignee. The disclosed method includes the steps of: reading a carton identifier that is physically associated with one of the cartons; accessing carton detail data associated with the carton using the carton identifier, the carton detail data including a list of items contained within the carton and a monetary value associated with each such item; associating a carton value with the carton, the carton value at least partially based on a summation of the monetary values associated with each of the items within the carton; associating a tracking identifier with the carton, the tracking identifier used for tracking the movement of the carton through a carrier's transportation system as it is transported to the consignee; storing the carton value and the carton identifier in association with the tracking identifier; and providing the tracking identifier and the carton identifier to one or more authorized persons.

In another embodiment of the present invention a system for fulfilling an order at a packing facility is disclosed, wherein an order includes a list of ordered goods that are to be packed into one or more cartons and shipped from said packing facility to a consignee. The system described includes an order number capture device for capturing an order number associated with an order; an order information storage device for storing data associated with the order; an item capture device for capturing an item identifier associated with each item to be placed into one of the cartons; and a computer system that is configured for performing a plurality of order fulfillment related operations.

In one embodiment, the computer system that is part of the order fulfillment system described above is configured for performing the steps of: receiving an order number from the order number capture device; retrieving order information data associated with the order number from the order information storage device, the order information data comprising a list of the ordered goods that are to be transported from the packing facility to the consignee; associating a first carton identifier with a carton, such carton to be used in the transporting of at least some of the ordered goods listed on the order; receiving at least one item identifier from the item capture device, each at least one item identifier associated with an item to be placed in the carton; validating each such item identifier against the order information data to determine whether the item corresponds to an ordered good that should be placed in the carton; and for each such item determined to be valid, recording the item identifier in association with the first carton identifier to provide an indication that the item was placed in the carton.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows a block diagram of an order fulfillment system in accordance with an embodiment of the present invention.

FIG. 2 shows a block diagram of an exemplary embodiment of the product pack work station computer of FIG. 1 in accordance with an embodiment of the present invention.

FIG. 3 shows a graphic illustration of an order fulfillment window of a type that would be displayed to a user working at a product pack work station in accordance with an embodiment of the present invention.

FIGS. 4A-4B depict a flowchart that generally illustrates some of the steps performed when using an order fulfillment system in accordance with an embodiment of the present invention.

FIG. 5 shows a block diagram of an exemplary embodiment of an order-related data structure stored on the order information database of FIG. 1 in accordance with an embodiment of the present invention.

FIG. 6 shows a block diagram of an exemplary embodiment of a carton-related data structure stored on the carrier shipping database of FIG. 1 in accordance with an embodiment of the present invention.

### DETAILED DESCRIPTION OF THE INVENTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

The present invention is described below with reference to block diagrams and flowchart illustrations of methods, apparatus (i.e., systems) and computer program products according to an embodiment of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions, which execute on the computer or other programmable data processing apparatus create means for implementing the functions specified in the system or flowchart blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems which perform the specified functions or steps, or combinations of special purpose hardware and computer instructions.

The present invention is generally directed to an improved order fulfillment system that provides a convenient and inexpensive way of ensuring the accuracy of items being packed at a packing location, that captures order-related detail data on a carton level, and that provides a way of determining an accurate carton value which can be used for such things as computing an appropriate COD (Cash On Delivery) or insurance value for each carton to be shipped to a consignee.

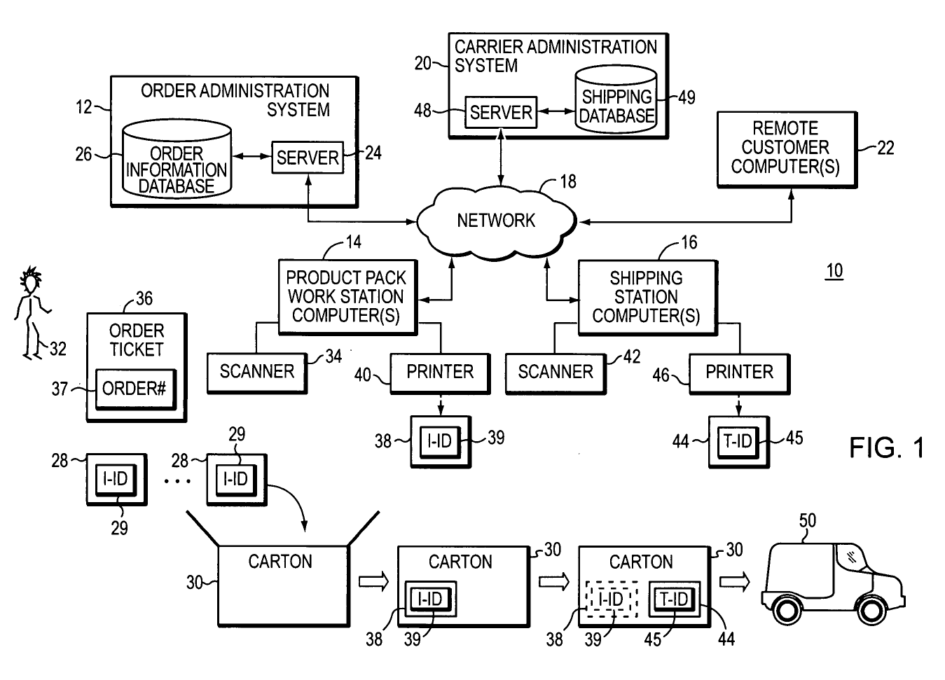

FIG. 1 shows a block diagram of an order fulfillment system 10 in accordance with an embodiment of the present invention. As may be understood from this figure, the order fulfillment system 10 includes an order administration system 12, one or more product pack work station computer(s) 14, one or more shipping station computer(s) 16, and a computer network 18. The system 10 further includes a carrier administration system 20 and one or more remote customer computer(s) 22.

As will be appreciated by one of ordinary skill in the art, the computer network 18 facilitates communication between the order administration system 12, the one or more product pack work station computer(s) 14, the one or more shipping station computer(s) 16, the carrier administration system 20, and the one or more remote customer computer(s) 22. The computer network 18 may include any of a variety of types and combinations of computer networks such as the Internet, a private intranet, a public switch telephone network (PSTN), or any other type of network known in the art. In one embodiment, the communication links between the order administration system 12, the product pack work station computer(s) 14 and the shipping station computer(s) 16 are implemented via a Local Area Network (LAN), while communications to and from the carrier administration system 20 and the remote customer computer(s) 22 are implemented primarily via the Internet.

The order administration system 12 includes a server 24 and an order information database 26. The order information database 26 is used for storing order-related data associated with each order that is to be packed at the packing location. An order consists of a list of ordered goods 28 that are to be packed into one or more cartons 30. Once packed, each carton 30 can be shipped from the packing location to a consignee. The order information database 26 generally includes, for each order, order information data 114 and one or more related sets of carton detail data 116. The order information data 114 associated with each order includes a list of the items 28 that make up that particular order. Depending on the size of the order, one or more cartons 30 may be needed to pack all of the items 28, which are listed in association with the current order.

As the packing of each such carton 30 occurs, the system 10 maintains a corresponding set of carton detail data 116. The carton detail data 116 associated with each carton 30 includes, but is not limited to, a list of the items 28 that have been placed into each particular carton. To uniquely identify each such carton 30 throughout the packing and shipping process, the system 10 generates a corresponding unique carton identifier 39. The unique carton identifier 39 associated with each carton 30 can be used at various points to access the carton detail data 116 that is associated with that carton.

According to one embodiment, the packing of an order begins by having a user 32 scan an order ticket 36. The order ticket 36 can, for example, be a printed sheet of paper, which includes a barcode label and other indicia related to the current order that is to be packed. Using an order number 37 obtained from the order ticket 36, the system 10 retrieves corresponding order information data 114, which, as indicated above, includes a list of the items 28 that are to be packed into one or more cartons 30, in association with the current order. Upon retrieval of the order information data 114, the user 32 begins placing product items 28 into a first carton 30. In the process of placing items 28 into the first carton 30, the user 32 scans each such item to obtain a corresponding item identifier 29. Each item identifier 29 is then used by the system 10 to perform a number of order fulfillment operations. Generally described, these operations include determining whether each such item 28 should be placed in the current carton 30, and, if so, recording that each such item was, therefore, placed in the carton.

When the first (or any) carton 30 becomes full, the user 32 can close out that carton by providing an indication to the system 10 that no more items will be placed in the current carton. The carton detail data 116 associated with that carton can be stored in association with the unique carton identifier 39, which was generated by the system 10. For each carton, all such data is further stored in association with current order number 37. If, after closing out the current carton 30, there remains unpacked items 28 associated with the open order, the system 10 can be used to generate yet another carton identifier 39 to be associated with a next carton 30. As such, the packing of the items 28 included in the current order can continue as generally described above until all such items are packed, or, alternatively, until the user 32 chooses to close the current order (and carton) regardless of whether all such items have been packed. In the latter case, the packing of such order can resume at a later time, with the events of the current packing session having been recorded by the system 10. These and other aspects of the present invention will now be described in more detail.

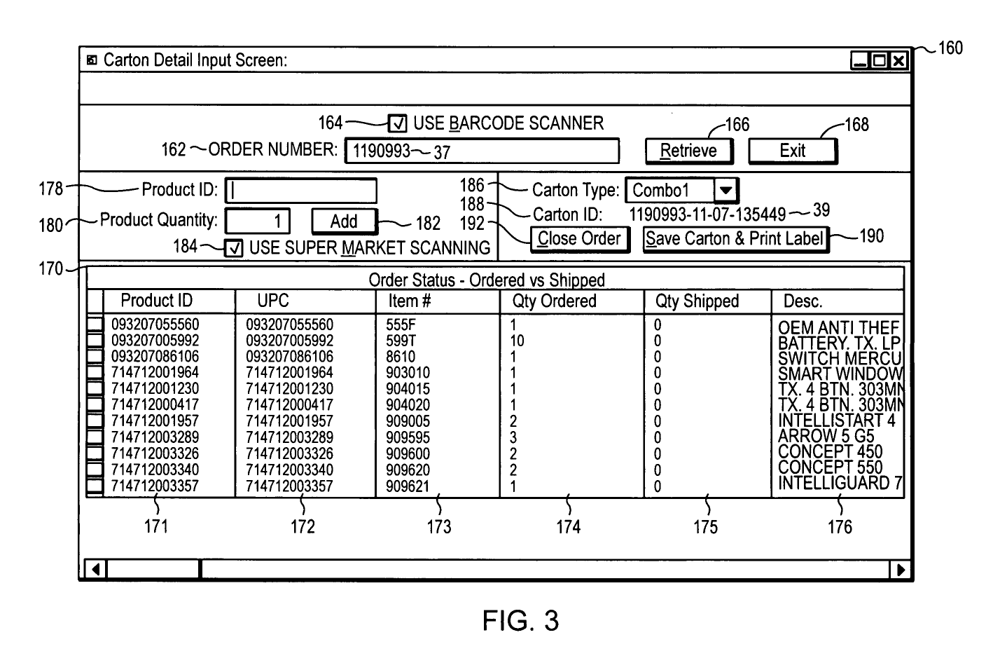

Specifically, in one embodiment, the product pack work station computer 14 of FIG. 1 can be used for recording and validating what items 28 are packed into each carton 30. Packing location personnel 32 can use a scanner 34 to scan the order ticket 36. The order ticket 36 contains an order number 37, which is used by the product pack work station computer 14 to retrieve corresponding order information data 114 from the order information database 26. Once retrieved, some or all of the order information data 114 can be displayed on a display device (not shown) that is connected to the product pack work station computer 14. Aspects of an exemplary display in accordance with the present invention will be described in more detail below, with regard to FIG. 3.

Continuing with FIG. 1, packing location personnel (or users) 32 can use the scanner 34 to scan each item 28 that is about to be added to the carton 30. The scanning of each item 28 is performed so as to obtain an item identifier 29, which is physically associated with each such item. The item identifier 29 may be stored on the item 28 in the form of a one- or two-dimensional barcode, an RFID tag, or some other automatic identification format, for example. In response to the input of each item identifier 29, the product pack work station computer 14 performs a series of validation operations to further ensure order fulfillment accuracy.

Such validation operations include determining whether the scanned item 28 is of a type indicated on the order, and if so, whether the aggregate quantity added to the current carton 30 is less than or equal to the number of items, of that type, remaining on the open order. In the event of a discrepancy, the user 32 can be prompted not to place the item 28 into the carton 30. As indicated above, a discrepancy can include a finding that the item 28 is not of a type listed on the order, or a finding that if the user was to place the current item into the carton 30, the number of items of that type (that will have been packed) would exceed the quantity listed on the order. If, on the other hand, there is no discrepancy found as to the current item 28, the user 32 is assumed to have placed the item 28 into the carton 30, and the product pack work station 14 correspondingly records the item as having been placed in the carton.

When it is determined that no more items 28 can (or will) be placed into the current carton 30, the product pack work station computer 14 can be prompted by the user 32 to save carton detail data 116 in association with the current carton. In particular, all carton detail data 116 pertaining to a given carton 30 is stored in association with a unique carton identifier 39, which ultimately is stored in association with the order number 37 to which that carton relates. All such information can be stored in the order information database 26. In addition to a list of the items 28 contained in a given carton 30, the carton detail data 116 can include, for example, a name of the user 32 who packed the carton, a time during which the carton was packed, the work station at which the carton was packed, etc.

Preferably, the carton detail data 116 associated with each carton 30 also includes a computed carton value 66. An accurate carton value 66 can be computed for each carton 30 by accessing pricing information data that corresponds to each of the items 28, which are known to be within that carton. The carton value 66 associated with each carton 30 can be used for a number of things, such as computing an accurate COD value or insurance value for the carton. Such values can be used, for example, by a carrier 50, such as UPS, which is responsible for transporting the carton 30 from the packing location to a respective consignee.

At some point in the process of packing each carton 30, the carton's corresponding unique carton identifier 39 comes to be physically associated such carton. According to one embodiment, this association is accomplished by printing the carton identifier 39 on an adhesive label 38, which is then affixed to an outer surface of the carton 30. In another embodiment, the carton identifier 39 can be programmed onto an automatic identification device, such as an RFID tag, that is physically associated with the carton 30. By physically associating each unique carton identifier 39 with each respective carton 30, the corresponding carton detail data 116 associated with such cartons can be accessed by one or more authorized persons, such as a shipper, a consignee, or carrier personnel, handling the cartons at various points throughout the packing and shipping process. The carton detail data 116 can also be provided to one or more remote customer computers 22 via the network 18. The remote customer computer 22 may, for example, be a computer that is being accessed by the consignee of the carton 30.

According to one embodiment, after being packed at a packing station 14, each carton 30 is moved from the packing station 14 to a shipping station 16, where additional operations are performed in connection with shipping said carton from the packing location to a respective consignee. The shipping station computer 16 can be used to generate a carrier-related tracking identifier 45 for tracking the movement of the carton 30 as it is transported from the packing location to the consignee. The tracking identifier 45 is of a type generally used by common carriers, such as UPS, to track the movement of a package (or carton 30) through a transportation system. The tracking identifier 45 can be printed on a shipping label 44 after being obtained in a known manner from the carrier administration system 20 via the network 18.

A scanner 42 connected to the shipping station computer 16 can be used to recognize the carton identifier 39, which is physically associated with each carton 30. The carton identifier 39 can then be used by the shipping station computer 16 to access (or compute) the carton value 66 for the carton 30. As mentioned above, the carton value 66 associated with the carton 30 is based on the known values of the items 28 contained within the carton 30, and can be used for such things as determining an accurate COD value to be charged to the consignee upon delivery of the carton, and for determining whether and for what amount a particular carton 30 should be insured.

The shipping station computer 16 is then used to store the carton identifier 39 in association with the tracking identifier 45, so that both tracking data 82 and carton detail data 116 associated with the carton 30 can be readily provided, throughout the shipping process, to one or more authorized persons. As will be described in further detail below, storage of the carton identifier 39 in association with the tracking identifier 45 can occur at one or both of the order information database 26 and the carrier shipping database 49. Note that in one embodiment, the product pack work station computer 14 and the shipping station computer 16 can be the same computer (i.e., in a given application, all such operations described above may be performed at a single station).

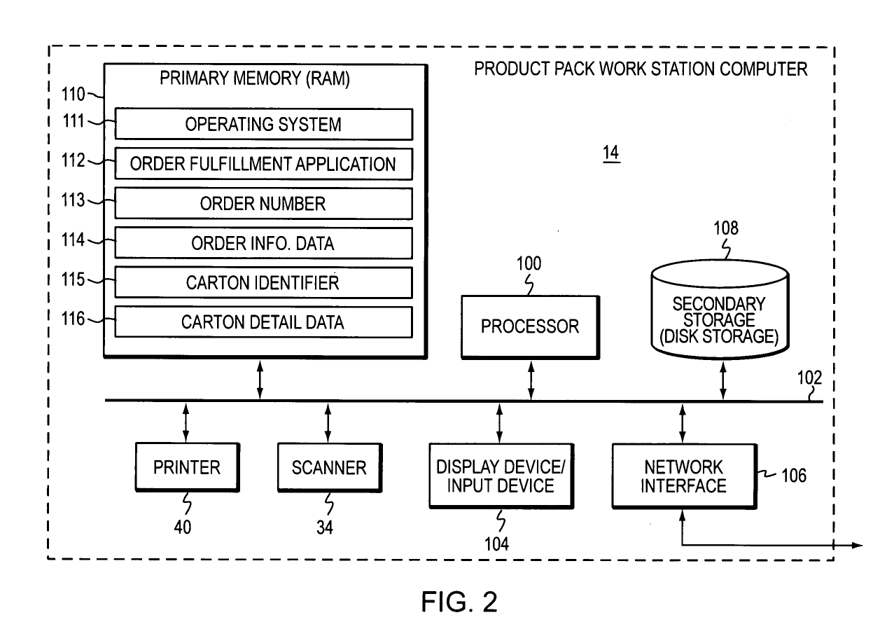

Reference is now made to FIG. 2, which shows a block diagram of an exemplary embodiment of the product pack work station computer 14 of FIG. 1. The work station computer 14 includes a processor 100 that communicates with other elements within the work station computer 14 via a system interface or bus 102. Also included in the work station computer 14 is a scanner 34, a printer 40, and a display device/input device 104. The display device/input device 104 may be, for example, a keyboard and pointing device that is used in combination with a monitor. The work station computer 14 further includes a primary memory module (RAM) 110, which is used to store a number of program modules and data items. Such program modules and data items include an operating system 111, an order fulfillment application 112, an order number 113, typically one of many, and corresponding order information data 114. Memory module 110 further includes a carton identifier 115, typically one of many, and corresponding carton detail data 116. With the assistance of the processor 100 and the operating system 111, the order fulfillment application 112 controls certain aspects of the operation of the order fulfillment system 10, as described above and in more detail below.

The work station computer 14 further includes at least one secondary storage device 108, such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these secondary storage devices 108 is connected to the system bus 102 by an appropriate interface. The storage devices 108 and their associated computer-readable media provide nonvolatile storage for the work station computer 14. It is important to note that the computer-readable media described above could be replaced by any other type of computer-readable media known in the art. Such media include, for example, magnetic cassettes, flash memory cards, and digital video disk.

Also located within the work station computer 14 is a network interface 106, for interfacing and communicating with other elements of a computer network 18. It will be appreciated by one of ordinary skill in the art that one or more of the work station computer 14 components may be located geographically remotely from other work station computer components. Furthermore, one or more of the components may be combined, and additional components performing functions described herein may be included in the work station computer 14.

Reference is now made to FIG. 3, which shows a graphic illustration of an order fulfillment window 160 of a type that would be displayed to a user 32 working at a product pack work station 14 in accordance with an embodiment of the present invention.

The order fulfillment window 160 includes an “Order Number” input field 162 for manually entering and/or displaying an order number 37 that corresponds to the order which is currently being packed. The window 160 also includes a first checkbox 164 for selecting whether or not the user 32 will enter order numbers 37 into the computer 14 using a scanner 34. If the “Use Barcode Scanner” checkbox 164 is not checked, the user can enter the order number 37 into the “Order Number” input field 162 using a standard input device such as a keyboard. According to other embodiments, order numbers 37 can also be received at the computer 14 from a remote source via the network 18. Once an order number 37 has been entered, the user 32 clicks or selects the “Retrieve” button 166 to retrieve order information data 114 that is associated with the current order number 37.

The display 160 also includes an “Order Status” area 170. The Order Status area 170 provides several data fields that are included in the order information data 114, which is associated with the open order number 37. Specifically, in the embodiment shown, the order information data 114 includes three item identification fields, each of which represents a type of identifier that could be used to identify the ordered goods 28 listed on the order. These fields include the “Product ID” field 171, the “UPC” (Universal Product Code) field 172, and the “Item #” field 173, any of which could be used (in a given application) as the item identifiers 29 described above with regard to FIG. 1.

For each type of ordered good listed on the order, the order information data 114 further includes a “Quantity Ordered” field 174 for indicating the number of items of that type that have been ordered, and a “Quantity Shipped” field 175 for indicating the number of items of that type that have already been shipped (i.e., packed in a previous carton 30). These two fields, the “Quantity Ordered” field 174 and the Quantity Shipped field 175, allow a user 32 (and the computer 14) to determine at all times the number of ordered goods 28 of each type that still need to be packed in association with the open order. The order information data 114 further includes a “Description” field 176 that provides a brief description of each type of item listed on the order. The order information data 114 can also include a unit price (not shown) for each type of item listed on the order. As described above, such pricing data can be used by the system 10 to compute an accurate carton value 66 for each carton packed.

The order fulfillment window 160 further includes a number of user interface controls that facilitate the input of information related to product items 28. To provide for manual entry of item identifiers 29 associated with items 28, the order fulfillment window 160 includes a “Product ID” input field 178, a “Product Quantity” input field 180, and an “Add” button 182. To manually record the packing of an item 28, a user 32 types the item's identifier 29 into the Product ID input filed 178, enters the number of such items being added to the carton 30 in the Product Quantity input field 180, and clicks the “Add” button 182. Alternatively, the window 160 also includes a second checkbox 184 that allows a user 32 to indicate that item identifiers 29 will be entered into the computer 14 by using a scanner 34. Once an item identifier 29 is entered into the computer 14, the order fulfillment system 10 performs the recording and validation operations described above.

The order fulfillment window 160 also includes a number of user interface controls that are associated with the carton 30 which is currently being packed. The carton-related controls include a “Carton Type” field 186 for entering or selecting the type of carton 30 being packed, and a “Carton ID” field 188 for displaying the unique carton identifier 39, which is generated by the order fulfillment system 10 for uniquely identifying the current carton 30 throughout the packing and shipping process.

The window 160 further includes a “Save Carton & Print Label” (save carton) button 190 that, when selected by a user 32, causes the order fulfillment system 10 to save carton detail data 116 in association with the currently displayed carton identifier 39. In the embodiment shown, clicking the save-carton button 190 also causes the order fulfillment system 10 to print a label 38, which contains the unique carton identifier 39 that is associated with the current carton 30. The carton label 38 can be affixed to the carton 30 so that when the carton is moved to a shipping station 16 (or some other point), carton detail data 116 stored in association with the carton identifier 39 can be retrieved by scanning the carton label 38.

When a user 32 closes out a carton 30 by selecting the save carton button 190, the order fulfillment system 10 determines whether the open order still includes items that need to be packed for shipment. If unpacked items do remain on the open order, the order fulfillment system 10 will prompt the user to initiate packing of such remaining items into another carton 30. If the user does not wish to pack any of the remaining items at this time, the user can select the “Close Order” button 192. For each of the one or more cartons 30 containing items 28 that are listed on a given order, respective carton identifiers 39 will be stored in association with corresponding order number 37.

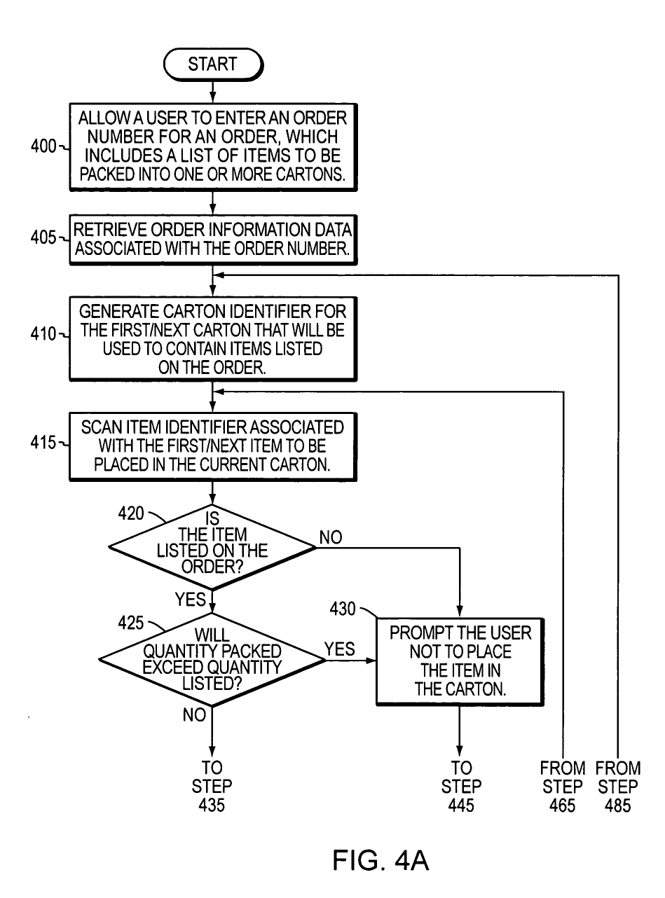

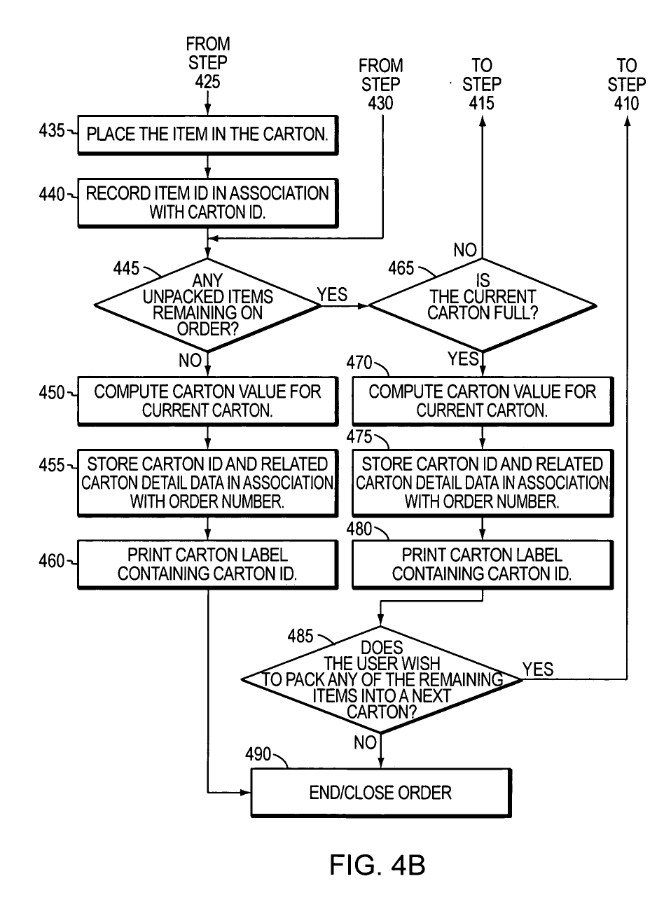

Reference is now made to FIGS. 4A-4B, which depict a flowchart that generally illustrates the steps performed when using an order fulfillment system in accordance with an embodiment of the present invention. As indicated above, some or all of the steps described below can be performed by a computer system which includes one or more computers. For example, the embodiment of FIG. 1 shows at least two computers, a product pack work station computer 14 and a shipping station computer 16. However, those of ordinary skill in the art will readily recognize that the functionality described herein could be performed on a single computer, which, for example, performs both packing and shipping operations, or on a number of distributed computer systems as described above.

Turning now to FIG. 4A, when using the order fulfillment system 10, at Step 400, the system first receives an order number 37 that is associated with an order comprising a list of items 28 that are to be packed for shipment into one or more cartons 30. The system then advances to Step 405 where it retrieves order information data associated with the order number 37. In one embodiment, the order information data can be retrieved from an order information database 26 via a network 18. At Step 410, the system generates a carton identifier 39 that will be associated with the first/next carton 30 that is to contain items 28 listed on the current order. Advancing to Step 415, the item identifier 29 associated with the first/next item 28 to be placed in the current carton 30 is scanned into the system 10. Using the item identifier 29, the system determines, at Step 420, whether the current item 28 is listed in association with the open order.

If the answer to the question posed at Step 420 is “no”, the system proceeds to Step 430 where it prompts the user 32 not to place the item 28 into the carton 30. If the answer is “yes”, however, the system proceeds to Step 425 where it determines whether the quantity packed, for the particular type of item 28, will exceed the quantity listed on the order, if the current item 28 is placed in the carton 30. If the answer to the question posed at Step 425 is “yes”, the system again proceeds to Step 430 where it prompts the user 32 not to place the item 28 into the carton 30.

If the item 28 is of a type listed on the order (Step 420), and placing the item in the carton 30 would not cause the quantity of that item-type packed to exceed the quantity of that item-type listed on the order (Step 425), then the system proceeds to Step 435 where the user 32 receives confirmation that the item 28 should be placed in the carton 30. Note that confirmation to place the item 28 in the carton 30 may, in one embodiment, simply consist of the lack of an indication not to place the item in the carton (i.e., Step 430 not being executed). If, however, the system prompts the user not to place the item 28 into the carton 30, the system proceeds from Step 430 directly to Step 445, where the system determines whether there are any unpacked items remaining on the open order. In other words, the system determines whether all of the ordered goods listed on the order have already been packed for shipment into a carton 30 (i.e., either the current carton or a previously packed carton). Note that the packing of an order, into one or more cartons, can occur over multiple, distinct packing sessions, and the results of what items are packed in which cartons, during each such session, will all be recorded by the system 10.

As shown in FIG. 4B, if the answer to the question posed at Step 445 is “no”, indicating that all of the items listed on the immediate order have now been packed into one or more cartons 30, the system proceeds to Step 450, where it computes a carton value 66 for the current carton. As described above, the carton value 66 is based on the known values of the individual items 28 contained within the carton 30. The carton value 66 associated with a given carton 30 can be used in a number of ways including, but not limited to, computing an accurate COD value to be charged to a consignee upon delivery of that particular carton, determining an appropriate insurance value for that carton, and for determining whether the value of that carton even warrants insurance, such as could be decided base on whether the computed carton value 66 exceeds a predetermined threshold.

In addition to computing a carton value 66 for the carton 30, the system, at Step 455, stores the corresponding carton identifier 39, and related carton detail data 116, in association with the order number 37. In one embodiment, the system also prints a carton label 38, at Step 460, that contains the carton identifier 39 associated with the current carton. As described above, the label 38 can be affixed to the carton 30 for uniquely identifying that carton at other points throughout the packing and shipping process. In another embodiment, the carton identifier 39 can be programmed onto an RFID tag (or other Automatic Identification device) that is physically associated with the carton 30. Being that there is no more ordered goods to pack in association with the current order, the system proceeds from Step 460 to Step 490, where execution of the system with regard to the current order is closed. A user 32 may then choose to initiate packing of a new order by repeating the processes described above for a new order number 37.

If, on the other hand, it is determined at Step 445 that there are additional or remaining items associated with the current order which have not yet been packed (into either the current or a previously-packed carton), the system proceeds to Step 465, where it determines whether the current carton 30 is full. In one embodiment, the determination of whether a carton is “full” is made by the user 32 who is packing the items 28 into the carton 30. In another embodiment, this determination can be made by the system based on such factors as the weight of the carton 30, which carton can be positioned on a digital scale communicatively connected to a product pack work station computer 14 during the packing process. In yet another embodiment, predetermined instructions or business rules received from the shipper or consignee, and included in the order information data 114 retrieved in association with the order number 37, can be used by the system to prompt the user 32 as to when no additional items (or perhaps no additional items of a certain type) should be placed into the current carton 30.

If it is determined, at Step 465, that the current carton 30 is not full, the system proceeds to Step 415, where the process of scanning the item identifier 29 associated with the next item 28 to be placed in the current carton is repeated.

If it is determined, at Step 465, that the current carton 30 is full (i.e., it is determined, based one or more reasons, that no more of the remaining items listed on the order will be placed in the current carton), the system proceeds to Step 470, where it computes a carton value 66 for the current carton, which, as described above, is based on the known values of the individual items contained within the carton 30, and can be used for such things as computing an accurate COD value to be charged to a consignee upon delivery of the particular carton, for determining an appropriate insurance value for the carton, and for determining whether the value of the carton even warrants insurance, such as could be decided based on whether the computed carton value exceeds a predetermined threshold. The system also proceeds to Step 475, where it store stores the corresponding carton identifier 39, and corresponding carton detail data 116, in association with the order number 37. At Step 480, the system prints a carton label 38 that contains the carton identifier 39 associated with the current carton. As described above, the label 38 can be affixed to the carton 30 for uniquely identifying the carton at other points throughout the packing and shipping process.

After executing Steps 470-480, the system proceeds to Step 485 where it allows the user 32 to indicate whether they wish to pack any of the remaining items 28 listed on the open order into a next carton 30. If the answer is “no”, the system proceeds to Step 490 where execution of the system with regard to the current order ends. Alternatively, if the answer to the question posed as Step 485 is “yes”, the system proceeds to Step 410, where it generates a new carton identifier 39 for the next carton 30 that will be used to contain remaining items 28 listed on the open order.

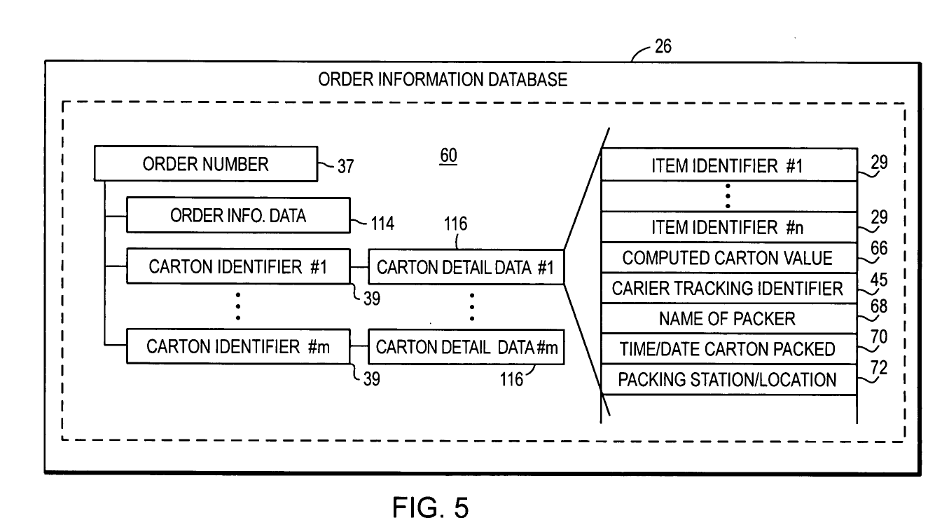

Reference is now made to FIG. 5, which shows a block diagram of an exemplary embodiment of an order-related data structure 60 that is stored in the order information database 26 of FIG. 1 in accordance with an embodiment of the present invention. The exemplary data structure 60 can be referenced in a number of ways including by an order number 37. Stored in association with the order number 37 is order information data 114 and one or more carton identifiers 39. Order information data 114 includes, but is not limited to, a list of ordered items 28 (not shown), which are to be packed into one or more cartons 30 and shipped to a consignee.

Associated with each carton identifier 39 is a set of carton detail data 116 that relates to each corresponding carton 30. Each set of carton detail data 116 includes one or more item identifiers 29 that correspond to respective items 28 contained within the carton 30, a carton value 66 determined in a manner described above, and a carrier tracking identifier 45 received from a common carrier, such as UPS. The carton detail data 116 can also include other data fields, such as an identity 68 of the individual who packed that carton, a time 70 during which the carton was packed, and a location or station 72 at which the carton was packed.

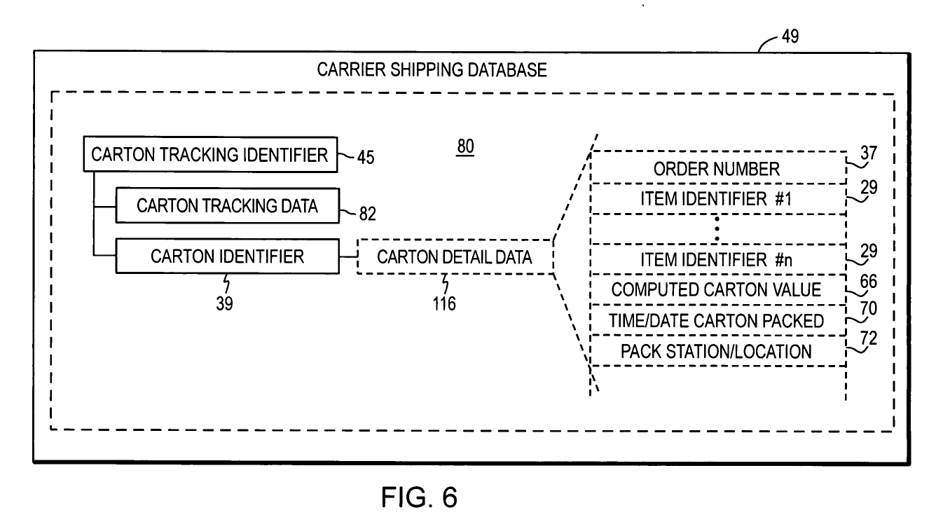

Reference is now made to FIG. 6, which shows a block diagram of an exemplary embodiment of a carton-related data structure 80 stored in the carrier shipping database 49 of FIG. 1 in accordance with an embodiment of the present invention. The exemplary data structure 80 can be referenced in a number of ways including by a tracking identifier 45. The carton tracking identifier 45 is of a type that is generally used by common carriers, such as UPS, to track the movement of a package (or carton 30) through a transportation system. Stored in association with the carton tracking identifier 45 is corresponding carton tracking data 82 and a carton identifier 39. The carton identifier 39 can be used for referencing carton detail data 116 that was recorded at a packing location where the carton 30 was packed.

In one embodiment, the carton detail data 116 can be stored locally in the carrier shipping database 49. In another embodiment, the carrier may instead only maintain the carton identifier 39, which can then be used, when necessary, to access a customer's order information database 26, such as shown in FIG. 1. In the embodiment of FIG. 6, the carton detail data 116 includes an order number 37 of which the carton 30 is associated with, one or more item identifiers 29 for identifying the items within the carton 30, and a computed carton value 66 such as can be used for determining an appropriate COD value or insurance value for the carton 30. The carton detail data 64 can include additional data fields, such as a time 70 and a location 72 at which the carton 30 was packed.

By accessing the types of data structures described above, one or more authorized persons (e.g., a consignee) interested in the status of a carton 30 can be provided with both carton tracking data 82 and carton detail data 116, which is associated with each such carton. This information can be provided to such persons in a variety of ways including, for example, via an email notification that provides an authorized link(s) to one or more of the data structures described above.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of fulfilling an order at a packing facility, said order comprising a list of ordered goods that are to be packed into one or more cartons and shipped from said packing facility to a consignee, said method comprising the steps of:
receiving at a computer an order number associated with said order;
retrieving order information data associated with said order number, said order information data including a list of said ordered goods that are to be transported from said packing facility to said consignee;
associating a carton identifier with a carton, said carton to be used in the transporting of at least some of the ordered goods listed on said order;
receiving at said computer at least one item identifier, each said at least one item identifier associated with an item to be placed in said carton;
validating each said at least one item identifier against said order information data to determine whether said item corresponds to an ordered good that should be placed in said carton; and
for each said item determined to be valid, recording said item identifier in association with said carton identifier to provide an indication that said item was placed in said carton.

2. The method of claim 1, wherein said validating step comprises determining whether each said item is of a type listed on said order.

3. The method of claim 2, wherein, if said item is of a type listed on said order, said validating step further comprises determining whether placement of said item in said carton would cause the number of items of said type that have been packed to exceed the number of items of said type that are listed on said order.

4. The method of claim 1, further comprising the step of generating a signal indicating that said item should not be placed in said carton if said validating step determines that said item is not valid.

5. The method of claim 1, further comprising the step of displaying said order information data to an operator who is positioned to place said items into said carton.

6. The method of claim 1, further comprising the step of receiving at said computer a carton-complete signal indicating that no more items are to be placed in said carton.

7. The method of claim 6, further comprising the step of printing a carton label to be affixed to said carton, said carton label comprising said carton identifier.

8. The method of claim 7, wherein said carton identifier is encoded on said carton label in the form of a bar code.

9. The method of claim 6, wherein said carton-complete signal further indicates that said current order is to be closed.

10. The method of claim 6, wherein said carton-complete signal further indicates that said current order is to remain open so that one or more of said ordered goods remaining on said order can be packed into a next carton.

11. The method of claim 6, further comprising the steps of:
accessing cost data related to each of the items within said carton, said cost data comprising a monetary value associated with each said item; and
associating a carton value with said carton, said carton value at least partially based on a summation of the monetary values associated with each of the items within said carton.

12. The method of claim 11, wherein said carton value further includes an amount charged by a carrier to ship said carton to said consignee.

13. The method of claim 11, wherein said carton value is used to determine an amount that is charged to said consignee upon delivery of said carton.

14. The method of claim 11, wherein said carton value is used to determine an insurance value for said carton.

15. The method of claim 14, wherein said insurance value is determined only if said carton value exceeds a certain threshold.

16. The method of claim 1, further comprising the step of storing in association with said carton identifier an indication of at least one of (a) who packed said items in said carton and (b) when said items were packed in said carton.

17. A method of fulfilling an order at a packing facility, said order comprising a list of ordered goods that are to be packed into at least two cartons and shipped from said packing facility to a consignee, said method comprising the steps of:
receiving at a computer an order number associated with said order;
retrieving order information data associated with said order number, said order information data comprising a list of said ordered goods that are to be transported from said packing facility to said consignee;
associating a first carton identifier with a first carton, said first carton to be used in the transporting of at least some of the items listed on said order;
receiving at said computer an item identifier for each said item to be placed in said first carton;
validating each said item to be placed in said first carton against said order information data to insure that each said item corresponds to an ordered good that should be placed in said first carton;
for each said item to be placed in said first carton that is determined to be valid, recording said item identifier in association with said first carton identifier;
receiving at said computer a carton-complete signal indicating that no more items are to be placed in said first carton, said carton-complete signal further indicating that said current order is to remain open so that one or more of said ordered goods remaining on said order can be packed into a second carton;
associating a second carton identifier with said second carton, said second carton to be used in the transporting of at least some of said remaining items listed on said order;
receiving at said computer an item identifier for each said item to be placed in said second carton;
validating each said item to be placed in said second carton against said order information data to insure that each said item corresponds to an ordered good that should be placed in said second carton; and
for each said item to be placed in said second carton that is determined to be valid, recording said item identifier in association with said second carton identifier.

18. A system for fulfilling an order at a packing facility, said order comprising a list of ordered goods that are to be packed into two or more cartons and shipped from said packing facility to a consignee, said system comprising:
an order number capture device for capturing an order number associated with said order;
an order information storage device for storing data associated with said order;
an item capture device for capturing an item identifier associated with each item to be placed into one of said cartons; and
a computer system including one or more computers, said computer system configured for:
receiving said order number from said order number capture device;
retrieving order information data associated with said order number from said order information storage device, said order information data comprising a list of said ordered goods that are to be transported from said packing facility to said consignee;
associating a first carton identifier with a first carton, said first carton to be used in the transporting of at least some of the items listed on said order;
receiving an item identifier from said item capture device for each said item to be placed in said first carton;
validating each said item to be placed in said first carton against said order information data to insure that each said item corresponds to an ordered good that should be placed in said first carton;
for each said item to be placed in said first carton that is determined to be valid, recording said item identifier in association with said first carton identifier;
receiving a carton-complete signal indicating that no more items are to be placed in said first carton, said carton-complete signal further indicating that said current order is to remain open so that one or more of said ordered goods remaining on said order can be packed into a second carton;
associating a second carton identifier with said second carton, said second carton to be used in the transporting of at least some of said remaining items listed on said order;
receiving an item identifier from said item capture device for each said item to be placed in said second carton;
validating each said item to be placed in said second carton against said order information data to insure that each said item corresponds to an ordered good that should be placed in said second carton; and
for each said item to be placed in said second carton that is determined to be valid, recording said item identifier in association with said second carton identifier.

19. A method of fulfilling an order at a packing facility, said order comprising a list of ordered goods that are packed into one or more cartons and shipped from said packing facility to a consignee, said method comprising the steps of:
reading a carton identifier that is physically associated with one of said cartons;
accessing carton detail data associated with said carton using said carton identifier, said carton detail data comprising a list of items contained within said carton and a monetary value associated with each said item;
associating a carton value with said carton, said carton value at least partially based on a summation of the monetary values associated with each of the items within said carton;
associating a tracking identifier with said carton, said tracking identifier used for tracking the movement of said carton through a carrier's transportation system as it is transported to said consignee;
storing said carton value and said carton identifier in association with said tracking identifier; and
providing said tracking identifier and said carton identifier to one or more authorized persons.

20. The method of claim 19, wherein said providing step comprises transmitting an email notification to said one or more authorized persons, said email notification comprising a link to tracking data associated with said tracking identifier and to carton detail data associated with said carton identifier, said carton detail data comprising a list of the items within said carton.

21. A system for fulfilling an order at a packing facility, said order comprising a list of ordered goods that are to be packed into one or more cartons and shipped from said packing facility to a consignee, said system comprising:
a data capture device for reading a carton identifier that is physically associated with one of said cartons;
an order information storage device for storing data associated with said order; and
a computer system including one or more computers, said computer system configured for:
receiving said carton identifier from said data capture device;
retrieving from said order information storage device carton detail data associated with said carton using said carton identifier, said carton detail data comprising a list of items contained within said carton and a monetary value associated with each said item;
associating a carton value with said carton, said carton value at least partially based on a summation of the monetary values associated with each of the items within said carton;
associating a tracking identifier with said carton, said tracking identifier used for tracking the movement of said carton through a carrier's transportation system as it is transported to said consignee;
storing said carton value and said carton identifier in association with said tracking identifier; and
providing said tracking identifier and said carton identifier to one or more authorized persons.

22. The system of claim 21, wherein said providing step comprises transmitting an email notification to said one or more authorized persons, said email notification comprising a link to tracking data associated with said tracking identifier and to carton detail data associated with said carton identifier, said carton detail data comprising a list of the items within said carton.

23. A system for fulfilling an order at a packing facility, said order comprising a list of ordered goods that are to be packed into one or more cartons and shipped from said packing facility to a consignee, said system comprising:
an order number capture device for capturing an order number associated with said order;
an order information storage device for storing data associated with said order;
an item capture device for capturing an item identifier associated with each item to be placed into one of said cartons; and
a computer system including one or more computers, said computer system configured for:
receiving said order number from said order number capture device;
retrieving order information data associated with said order number from said order information storage device, said order information data comprising a list of said ordered goods that are to be transported from said packing facility to said consignee;
associating a carton identifier with a carton, said carton to be used in the transporting of at least some of the ordered goods listed on said order;
receiving at least one item identifier from said item capture device, each said at least one item identifier associated with an item to be placed in said carton;
validating each said item identifier against said order information data to determine whether said item corresponds to an ordered good that should be placed in said carton; and
for each said item determined to be valid, recording said item identifier in association with said carton identifier to provide an indication that said item was placed in said carton.

24. The system of claim 23, wherein said validating step comprises determining whether each said item is of a type listed on said order.

25. The system of claim 24, wherein, if said item is of a type listed on said order, said validating step further comprises determining whether placement of said item in said carton would cause the number of items of said type that have been packed to exceed the number of items of said type that are listed on said order.

26. The system of claim 23, wherein said computer system is further configured for generating a signal indicating that said item should not be placed in said carton if it is determined in said validating step that said item is not valid.

27. The system of claim 23, wherein said system further comprises a display device, and said computer system is further configured for displaying said order information data on said display device for an operator who is positioned to place said items into said carton.

28. The system of claim 23, wherein said computer system is further configured for receiving a carton-complete signal indicating that no more items are to be placed in said carton.

29. The system of claim 28, wherein said system further comprises a printer device, and said computer system is further configured for printing a carton label to be affixed to said carton, said carton label comprising said carton identifier.

30. The system of claim 28, wherein said carton-complete signal further indicates that said current order is to be closed.

31. The system of claim 28, wherein said carton-complete signal further indicates that said current order is to remain open so that one or more of said ordered goods listed on said order can be packed into a next carton.

32. The system of claim 28, wherein said computer system is further configured for:
accessing cost data related to each of the items within said carton, said cost data comprising a monetary value associated with each said item; and
associating a carton value with said carton, said carton value at least partially based on a summation of the monetary values associated with each of the items within said carton.

33. The system of claim 32, wherein said carton value further includes an amount charged by a carrier to ship said carton to said consignee.

34. The system of claim 32, wherein said carton value is used to determine an amount that is charged to said consignee upon delivery of said carton.

35. The system of claim 32, wherein said carton value is used to determine an insurance value for said carton.

36. A method of fulfilling an order at a packing facility, said order comprising a list of ordered goods that are to be packed into one or more cartons and shipped from said packing facility to a consignee, said method comprising the steps of:
receiving at a computer an order number associated with said order;
retrieving order information data associated with said order number, said order information data comprising a list of said ordered goods that are to be transported from said packing facility to said consignee;
associating a carton identifier with a carton, said carton to be used in the transporting of at least some of the ordered goods listed on said order;
receiving at said computer at least one item identifier, each said at least one item identifier associated with an item to be placed in said carton;
validating each said at least one item identifier against said order information data to determine whether said item corresponds to an ordered good that should be placed in said carton;
for each said item determined to be valid, recording said item identifier in association with said carton identifier to provide an indication that said item was placed in said carton;
receiving at said computer a carton-complete signal indicating that no more items are to be placed in said carton;
associating a tracking identifier with said carton, said tracking identifier used for tracking the movement of said carton through a carrier's transportation system;
storing said tracking identifier in association with said carton identifier; and
providing said tracking identifier and said carton identifier to at least one authorized person.

37. The method of claim 36, wherein said providing step comprises transmitting an email notification to said at least one authorized person, said email notification comprising a link to tracking data associated with said tracking identifier and to carton detail data associated with said carton identifier, said carton detail data comprising a list of the items within said carton.

38. A system for fulfilling an order at a packing facility, said order comprising a list of ordered goods that are to be packed into one or more cartons and shipped from said packing facility to a consignee, said system comprising:
an order number capture device for capturing an order number associated with said order;
an order information storage device for storing data associated with said order;
an item capture device for capturing an item identifier associated with each item to be placed into one of said cartons; and
a computer system including one or more computers, said computer system configured for:
receiving said order number from said order number capture device;
retrieving order information data associated with said order number from said order information storage device, said order information data comprising a list of said ordered goods that are to be transported from said packing facility to said consignee;
associating a carton identifier with a carton, said carton to be used in the transporting of at least some of the ordered goods listed on said order;
receiving at least one item identifier from said item capture device, each said at least one item identifier associated with an item to be placed in said carton;
validating each said item identifier against said order information data to determine whether said item corresponds to an ordered good that should be placed in said carton;
for each said item determined to be valid, recording said item identifier in association with said carton identifier to provide an indication that said item was placed in said carton;
associating a tracking identifier with said carton, said tracking identifier used for tracking the movement of said carton through a carrier's transportation system;
storing said tracking identifier in association with said carton identifier; and
providing said tracking identifier and said carton identifier to at least one authorized person.

39. The system of claim 38, wherein said providing step comprises transmitting an email notification to said at least one authorized person, said email notification comprising a link to tracking data associated with said tracking identifier and to carton detail data associated with said carton identifier, said carton detail data comprising a list of the items within said carton.
